(19) United States
(12) Patent Application Publication
(10) Pub. No.: US 2001/0011302 A1
(43) Pub. Date: Aug. 2, 2001

(54) METHOD AND APPARATUS FOR VOICE ACTIVATED INTERNET ACCESS AND VOICE OUTPUT OF INFORMATION RETRIEVED FROM THE INTERNET VIA A WIRELESS NETWORK

(76) Inventor: WILLIAM Y. SON, SAN DIEGO, CA (US)

Correspondence Address: LYON & LYON LLP, SUITE 4700, 633 WEST FIFTH STREET, LOS ANGELES, CA, 90071-2066, US

(21) Appl. No.: 09/108,570

(22) Filed: Jul. 1, 1998

(30) Foreign Application Priority Data
Oct. 15, 1997 (KR) 52812/1997
Oct. 15, 1997 (KR) 52813/1997

(51) Int. Cl. G06F 15/173; G06F 15/16; G10L 11/00

(52) U.S. Cl. 709/225; 709/203; 704/270.1

(57) ABSTRACT

A method and apparatus providing voice-interactive access to the internet via wireless networks enabling a subscriber, while driving or performing other tasks, to input commands to the internet using a voice input function, such as voice recognition, and retrieve the information from the internet using a voice output function, such as voice synthesis. The present invention allows a subscriber to enter voice commands at an internet terminal, as well as commands through other external interfaces, such as a key pad or touch screen. The internet terminal can also display and store the received data from the internet. in addition to the output by voice synthesis. The present invention may utilize a hands-free kit, allowing the subscriber to drive a car or perform other tasks and receive the internet information without any additional action on the part of the subscriber.

### BACKGROUND OF THE INVENTION

The present invention relates to an apparatus and method for accessing the internet via wireless networks and, more particularly, to an apparatus and method providing voice-interactive access to the internet via wireless networks enabling a subscriber, while driving or performing other tasks, to access the internet.

The internet was originally developed in the 1960's to provide special types of military communications, but since has become a means for supporting information in many essential areas, such as finance, education and industry. The internet has also become a means for inexpensive international telephone service. Consequently, extensive effort has been expended to improve the speed and types of internet services, especially internet service that is not limited by geographic location or time of day.

Referring to FIG. 1, a conventional wireless network providing mobile internet access includes a mobile internet terminal unit 100, a base station 200, a wireless communication network 210, a gateway 220, an internetwork 230, a Web server 240, a mobile internet service protocol unit 250, an intranetwork 260, and a database unit 270. The internet terminal unit 100 includes an external interface, such as a key pad or touch screen, through which internet commands are entered into the unit. The terminal unit 100 then modulates and transmits the internet commands in the form of radio frequency (RF) signals to the base station 200. The base station 200 receives the RF signals from the internet terminal unit 100 and demodulates the signals to retrieve the original internet commands. The wireless communication network 210 then adds an identification number to the internet commands to indicate the particular internet terminal unit 100 from which the commands were received. The internet commands and identification numbers are then converted into a format that is suitable for transmission to the gateway 220. The gateway 220 then converts the internet commands and identification numbers to an internet protocol, such as TCP/IP (Transfer Control Protocol/Internet Protocol) or HTTP (HyperText Transfer Protocol). The internetwork 230 connects the gateway 220 to other networks in response to the internet commands received from the gateway 220. The Web server 240 provides World Wide Web information for the internetwork 230 and the mobile internet service protocol unit 250 connects the internetwork 230 to the intranetwork 260. The database unit 270 is connected to the intranetwork 260 to provide information upon request.

Referring to FIG. 2, the internet terminal unit 100 includes a command processing unit 110, a data signal processing unit 120, an RF signal processing unit 130, and an information processing unit 140. The command processing unit 110 receives the internet commands through the external interface and converts the commands into a format that is compatible with the protocol used between the wireless communication network 210 and the gateway 220. The data signal processing unit 120 receives the converted commands from the command processing unit 110 and converts the commands into a frame format. The RF signal processing unit 130 modulates the formatted internet commands to generate RF signals that are transmitted to the base station 200. The information processing unit 140 displays and stores information received from the internetwork 230.

The command processing unit 110 includes a command input unit 111 and a command transformation unit 112. The command input unit 111 receives the internet commands through the external interface and the command transformation unit 112 converts the commands into a format that is compatible with the protocol used between the wireless communication network 210 and the gateway 220.

The information control unit 140 includes an information display unit 141, an information storage unit 142 and an information control unit 143. The display unit 141 receives the internet information from the data signal processing unit 120 and displays it in a panel, window, or screen. The storage unit 142 also receives the internet information from the data signal processing unit 120 and stores it in memory for later use. The control unit 143 controls the display unit 141 and the storage unit 142.

Referring to FIGS. 1 and 2, the operation of the conventional wireless network providing mobile internet access will now be described. First, a subscriber inputs internet commands through the external interface, such as a key pad or touch screen, into the command input unit 111. The internet commands are then transformed by the command transformation unit 112 into a format that is compatible with the protocol used between the wireless communication network 210 and the gateway 220. The data signal processing unit 120 provides certain processing to ensure reliable transmission of the data across a wireless channel and converts the internet commands into a frame format. The RF signal processing unit 130 modulates the formatted internet commands to generate RF signals that are transmitted to the base station 200.

The base station 200 demodulates the received RF signals to retrieve the internet commands. The wireless communication network 210 converts the commands into HDML (HyperData Markup Language), a protocol used to provide internet service through wireless networks. The gateway 220 converts the commands into the TCP/IP format and accesses the internetwork 230 using an internet protocol(IP) address from the ID number of the internet terminal unit 100.

The internetwork 230 accesses the Web server 240 using HTML (HyperText Markup Language), a protocol used for Web service. The Web server 240 is connected to the intranetwork 260 by way of the mobile internet service protocol unit 250 using the TCP/IP protocol, thus allowing a subscriber on the intranetwork 260 to request Web information. Information can also be retrieved by the internetwork 230 from the database unit 270 of the intranetwork 260.

Transmission of information from the internetwork 230 to the internet terminal unit 100 is accomplished in reverse. First, after information from the Web server 240 or the intranetwork 260 is received, the internetwork 230 sends the information to the gateway 220. The gateway 220 sends the information to the wireless communication network 210 using the HDML protocol. The wireless communication network 210 transmits the information to the internet terminal unit 100 by way of the base station 200 using the ID number of the internet terminal unit 100.

The RF signal processing unit 130 in the internet terminal unit 100 demodulates the RF signals from the base station 200 and reconstructs the original data by decoding the demodulated data. The data is displayed in the information display unit 141 and stored in the storage unit 142 under the control of the information control unit 143.

Therefore, when a subscriber desires access to the internet using a conventional wireless network, the subscriber must use an external interface to request a connection to the internet or to enter a command. This is particularly difficult when the subscriber is driving an automobile or performing other tasks. Accordingly, there has been a need for an improved method and apparatus for accessing the internet using wireless networks. The present invention clearly fulfills this need.

### SUMMARY OF THE INVENTION

A method and apparatus providing voice-interactive access to the internet via wireless networks enabling a subscriber, while driving or performing other tasks, to input commands to the internet using a voice input function, such as voice recognition, and retrieve the information from the internet using a voice output function, such as voice synthesis. The present invention allows a subscriber to enter voice commands at an internet terminal, as well as commands through other external interfaces, such as a key pad or touch screen. The internet terminal can also display and store the received data from the internet in addition to the output by voice synthesis. The present invention may utilize a hands-free kit, allowing the subscriber to drive a car or perform other tasks and receive the internet information without any additional action on the part of the subscriber.

It will be appreciated from the foregoing that the present invention represents a significant advance in the field of internet access using wireless networks. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a block diagram of a conventional wireless network providing mobile internet access;

FIG. 2 is a block diagram of an internet terminal unit used to provide mobile internet access;

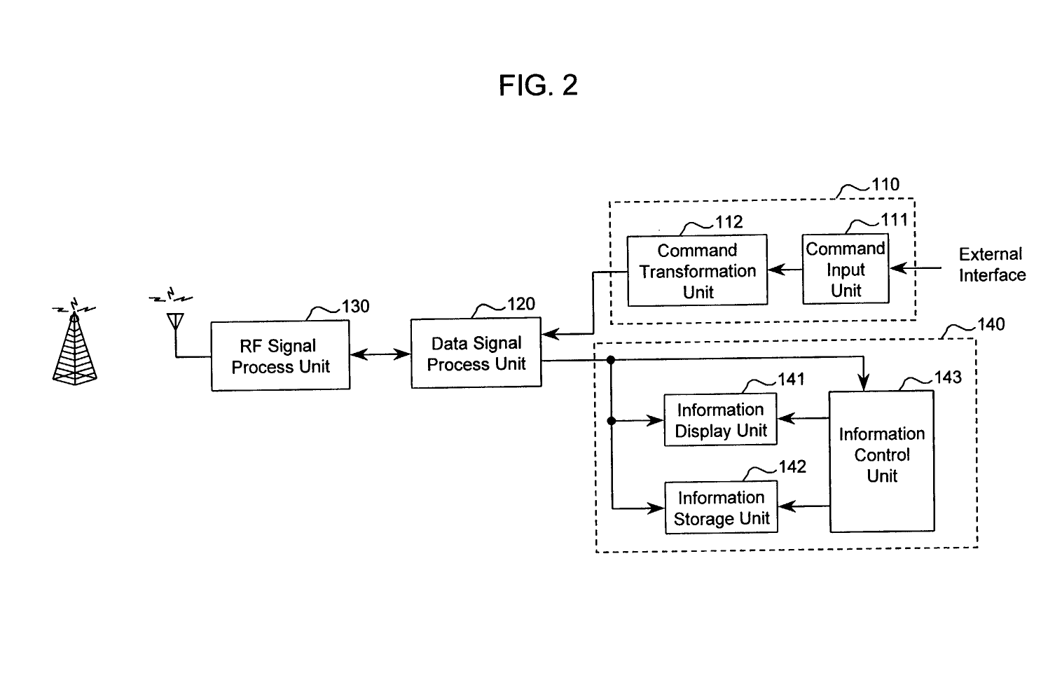

FIG. 3 is a block diagram of an apparatus providing voice-interactive access to the internet via wireless networks in accordance with a preferred embodiment of the present invention; and

FIG. 4 is a block diagram of an apparatus providing voice-interactive access to the internet via wireless networks in accordance with another preferred embodiment of the present invention.

### DETAILED DESCRIPTION OF THE PREFERRED EMBODIMENTS

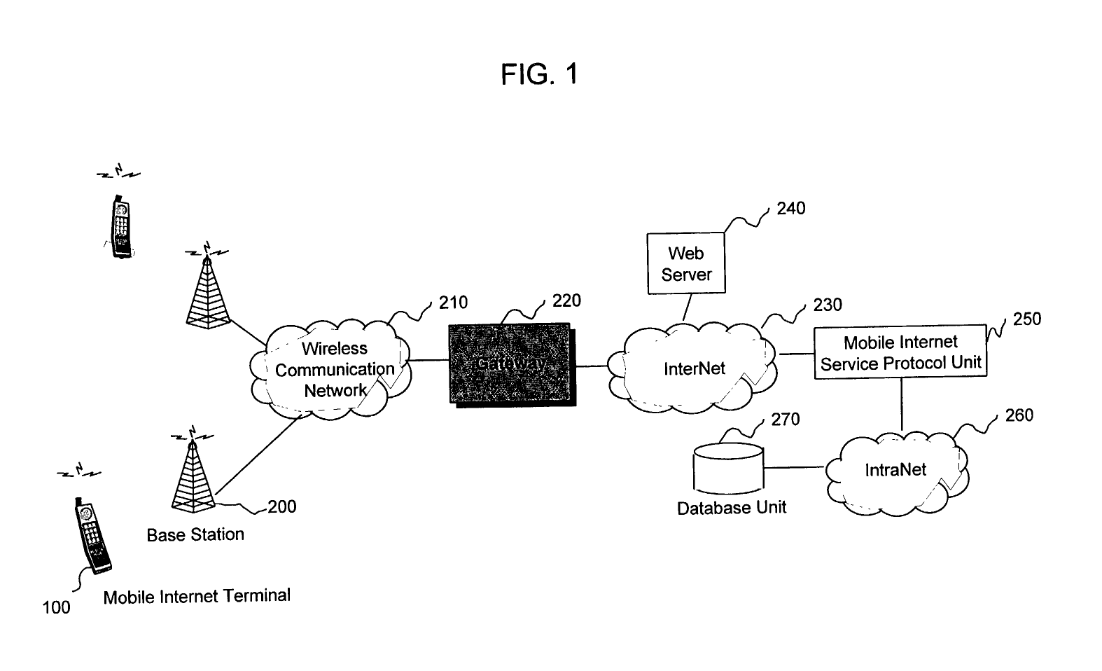

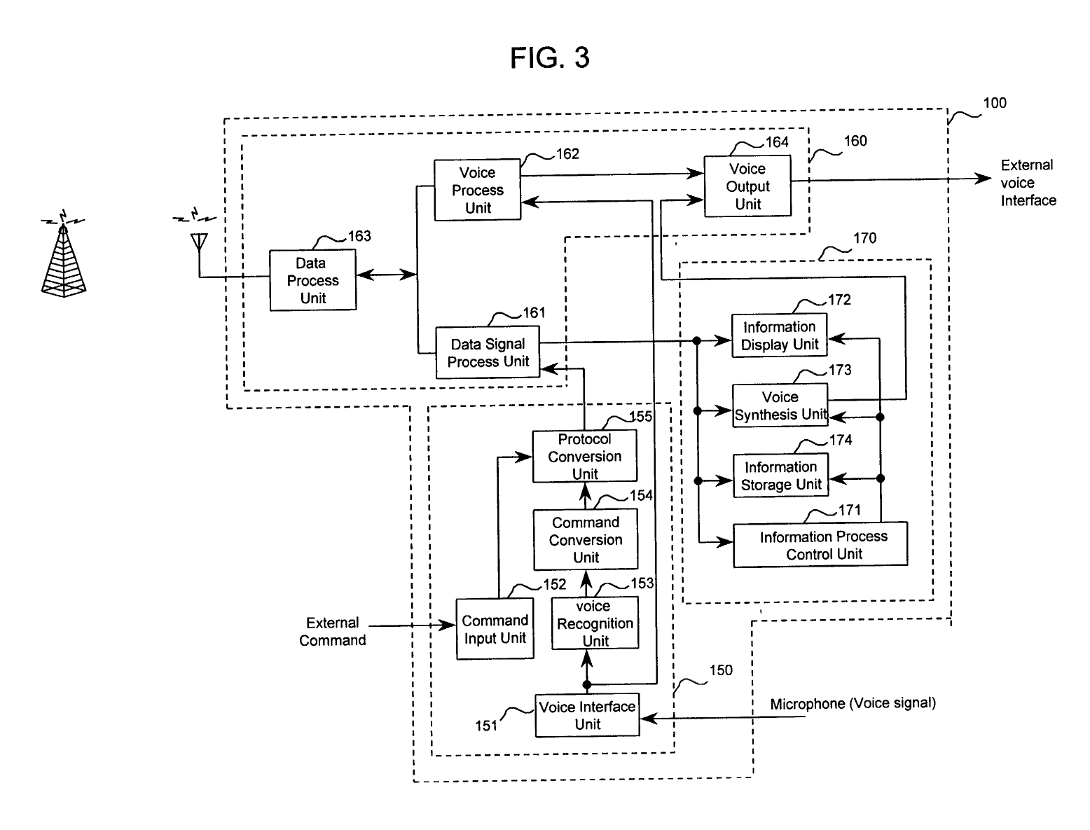

FIG. 3 is a block diagram illustrating a preferred embodiment of an apparatus providing voice-interactive access to the internet via wireless networks. The apparatus of the preferred embodiment of the present invention includes a command control unit 150, a data transceiver unit 160, and an information processing unit 170. A subscriber enters internet commands into the command control unit 150 through voice or other external interfaces. The command control unit 150 converts the commands into a format that is compatible with the protocol used between the wireless communication network 210 and the gateway 220 (shown in FIG. 1). The data transceiver unit 160 converts the internet commands into a frame format and transmits the commands to the base station 200 as radio frequency (RF) signals. The information retrieved from the internetwork 230 in response to the internet commands is transmitted back to the data transceiver unit 160 from the internetwork 230. The information retrieved from the internetwork 230 is displayed and stored in the information processing unit 170. The information is converted into a voice signal though voice synthesis in the information processing unit 170 and output to the subscriber by the data transceiver unit 160.

The command control unit 150 includes a voice interface unit 151, an external command input unit 152, a voice recognition unit 153, a command conversion unit 154, and a protocol conversion unit 155. The voice interface unit 151 converts the voice commands requesting an internet connection or internet information into a digital format. The voice interface unit 151 also converts voice communications from the subscriber into a digital format, such as when the subscriber uses the internet for conventional telephony. The voice interface unit 151 sends the converted voice commands to the voice recognition unit 153 and the converted voice communications to the data transceiver unit 160. The command input unit 152 receives the commands entered by the subscriber through other external interfaces. The voice recognition unit 153 receives the voice commands from the voice interface unit 151 and uses voice recognition to convert the commands into a text format. The command conversion unit 154 converts the digital voice commands from the voice recognition unit 153 into commands that are compatible with the internet service. The protocol conversion unit 155 receives the commands from the external command input unit 152 and the command conversion unit 154 and converts the commands into a format that is compatible with the protocol used between the wireless communication network 210 and the gateway 220. The converted commands are then sent to the data transceiver unit 160.

The data transceiver unit 160 includes a data signal processing unit 161, a voice processing unit 162, a data processing unit 163, and a voice output unit 164. The data signal processing unit 161 converts the commands from the command control unit 150 into a frame format and also reconstructs the internet information received from the base station 200. The voice processing unit 162 converts the voice communications from the command control unit 150 into a frame format and converts the voice communications received from the base station 200 into a digital format. The data processing unit 163 modulates the internet commands/voice communications received from the data signal processing unit 161 and the voice processing unit 162 and transmits these signals as RF signals to the base station 200. The data processing unit 163 also demodulates the RF signals received from the base station 200. The voice output unit 164 receives the voice communications from the voice processing unit 162 and the voice-synthesized internet information from the information processing unit 170, converts these voice signals into an analog format, and outputs the signals to an external voice interface, such as a speaker.

The information processing unit 170 includes an information processing control unit 171, an information display 172, a voice synthesis unit 173, and an information storage unit 174. The information processing control unit 171 controls the information processing unit 170 using the internet information from the data signal processing unit 161. The information display unit 172 receives the internet information from the data signal processing unit 161 and control messages from the information processing control unit 171. The internet information is displayed on a display interface, such as a panel, window, or screen. The voice synthesis unit 173 receives the internet information from the data signal processing unit 161 and control messages from the information processing control unit 171. The voice synthesis unit 173 then synthesizes the text data into a voice signal for output to the subscriber by the voice output unit 164. The information storage unit 174 stores the internet information from the data signal processing unit 161 in memory for later use in response to control messages from the information processing control unit 171.

The operation of the preferred embodiment of the present invention will now be described. First, a subscriber enters an internet command either by a key pad, a pen mouse or a touch screen, or by speaking into the microphone. The internet commands entered through the microphone are converted from an analog into a digital signal by the voice interface unit 151. The voice interface unit 151 sends the converted voice commands to the voice recognition unit 153. Voice communications are also converted from an analog into a digital format by the voice interface unit 151 and sent to the voice processing unit 162.

The internet commands are converted into a text format using voice recognition by the voice recognition unit 153 and converted into commands that are compatible with the internet service by the command conversion unit 154. Then, the converted voice commands and the commands entered through the external interface are converted by the protocol conversion unit 155 into a format supported by the internet protocol. The converted commands are then sent to the data transceiver unit 160.

The internet commands/voice communications are transmitted to the base station 200 as RF signals by the data transceiver unit 160. The data signal processing unit 161 receives the internet commands from the command control unit 150 and converts the commands into a frame format. The data processing unit 163 then modulates and transmits the internet commands and voice communications to the base station 200. The remaining operation of the wireless network is the same as previously described.

The operation in reverse will now be described. The RF signals transmitted by the base station 200 containing internet information and voice communications are demodulated by the data processing unit 163. The internet information and voice communications are converted into their original digital format. The internet information is then sent to the data signal processing unit 161 and the information processing unit 170, while the voice communications are sent to the voice processing unit 162. The information processing unit 170 applies voice synthesis to the internet information. The synthesized internet information and the voice communications are then converted from a digital to an analog format in the voice output unit 164 and output to an external voice interface, such as a speaker.

The information processing unit 170 receives the internet information from the internetwork 230 and the information display unit 172 displays the information in a display interface, such as a panel, window, or screen. The information storage unit 174 stores the internet information in memory for later use. The information display unit 172 and the information storage unit 174 are under the control of the information processing control unit 171.

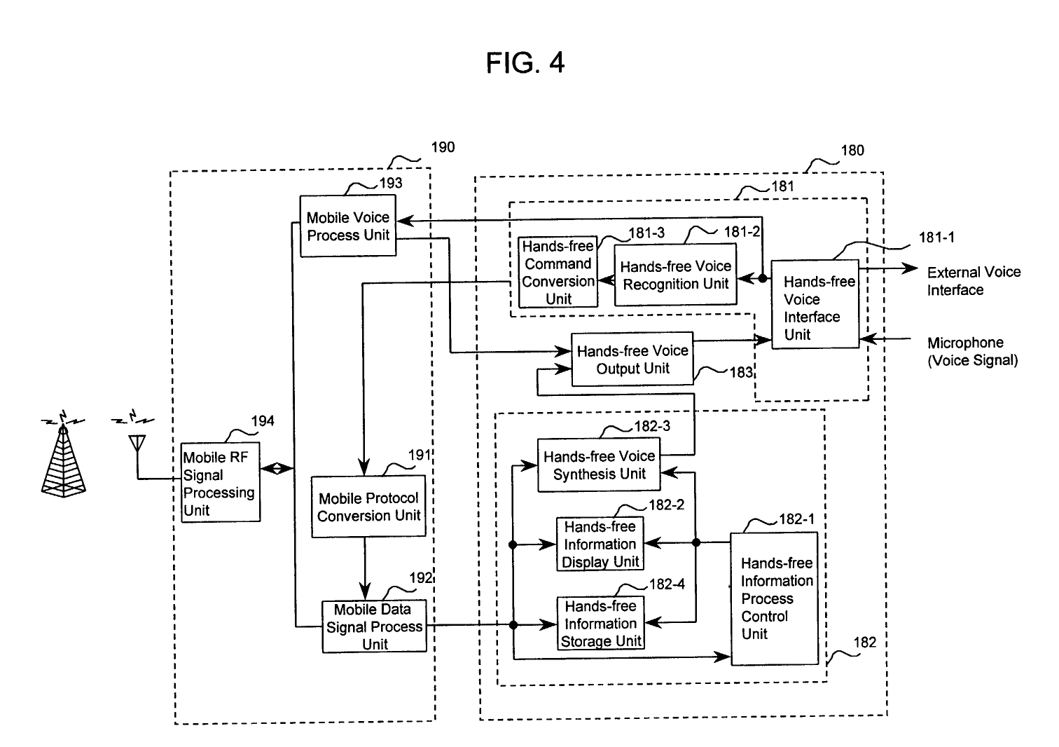

FIG. 4 is a block diagram illustrating another preferred embodiment of an apparatus providing voice-interactive access to the internet via wireless networks. This preferred embodiment utilizes a hands-free kit for accessing the internet. The apparatus of the present invention includes a hands-free kit unit 180 and a mobile transceiver unit 190. A subscriber enters internet commands into the hands-free kit 180 through voice or other external interfaces. The mobile transceiver unit 190 converts the internet commands from the hands-free kit unit 180 into a format that is compatible with the protocol used between the wireless communication network 210 and the gateway 220 (shown in FIG. 1). The mobile transceiver unit 190 then transmits the commands to the base station 200 as RF signals. The internet information retrieved from the internetwork 230 in response to the commands is displayed and stored by the hands-free kit 180. The internet information is also converted into a voice signal by voice synthesis and output to an external voice interface, such as a speaker.

The hands-free kit unit 180 includes a command control unit 181, an information processing unit 182, and a voice output unit 183. The command control unit 181 receives the internet commands from the subscriber through voice or other external interfaces and converts the commands into a format that is compatible with the internet service. The information processing unit 182 displays the internet information from the mobile transceiver unit 190 in a text format and converts the information into a voice signal by voice synthesis. The voice output unit 183 receives voice communications from the mobile transceiver unit 190 and the voice-synthesized information from the information processing unit 182, converts these signals into an analog format, and outputs the signals to an external voice interface, such as a speaker.

The command control unit 181 includes a voice interface unit 181-1, a voice recognition unit 181-2, and a command conversion unit 181-3. The voice interface unit 181-1 converts the voice commands requesting an internet connection or internet information into a digital format. The voice interface unit 181-1 also converts voice communications form the subscriber into a digital format and sends these signals to the mobile transceiver unit 190. The voice recognition unit 181-2 converts the voice commands from the voice interface unit 181-1 into a text format using voice recognition. The command conversion unit 181-3 converts the voice commands from the voice recognition unit 181-2 into a format that is compatible with the internet service.

The information processing unit 182 includes an information processing control unit 182-1, an information display unit 182-2, a voice synthesis unit 182-3, and an information storage unit 182-4. The information processing control unit 182-1 controls the information processing unit 182 using the internet information received from the mobile transceiver unit 190. The information display unit 182-2 receives the internet information from the mobile transceiver unit 190 and control messages from the information processing control unit 182-1 and displays the internet information in a display interface, such as a panel, window, or screen. The voice synthesis unit 182-3 receives the internet information from the mobile transceiver unit 190 and control messages from the information process control unit 182-1 and converts the text data into a voice signal using voice synthesis. The voice signal is then sent to the voice output unit 183. The information storage unit 182-4 stores the internet information from the mobile transceiver unit 190 in memory for later use in accordance with control messages from the information processing control unit 181-1.

The mobile transceiver unit 190 includes a protocol conversion unit 191, a data signal processing unit 192, a voice processing unit 193, and an RF signal processing unit. The protocol conversion unit 191 receives the internet commands from the command conversion unit 181-3 and converts the commands into a format compatible with the protocol used between the wireless communication network 210 and the gateway 220. The data signal processing unit 192 converts the commands from the protocol conversion unit 191 into a frame format. The data signal processing unit 192 also reconstructs the internet information received from the base station 200 and sends the information to the information processing unit 182. The voice processing unit 193 converts the voice communications from the command control unit 181 into a frame format and converts the voice communications received from the base station 200 into a digital format. The RF signal processing unit 194 modulates the internet commands/voice communications received from the data signal processing unit 192 and the voice processing unit 193 and transmits these signals to the base station 200 as RF signals. The RF signal processing unit 194 also demodulates the RF signals received from the base station 200 and converts the demodulated signals into a frame format.

The operation of the preferred embodiment of the present invention using the hands-free kit unit 180 will now be described. First, a subscriber enters an internet command by speaking into the microphone. The internet commands are then converted into a digital format by the voice interface unit 181-1 and sent to the voice recognition unit 181-2. Voice communications are also converted into a digital format by the voice interface unit 181-1 and sent to the voice processing unit 193. The voice commands are converted into a text format using voice recognition by the voice recognition unit 181-2 and converted into commands that are compatible with the internet service by the command conversion unit 181-3.

The protocol conversion unit 191 then converts the internet commands into a format supported by the internet protocol. The data signal processing unit 192 converts the internet commands from the protocol conversion unit 191 into a frame format and sends the converted commands to the RF signal processing unit 194. The internet commands from the data signal processing unit 192 and the voice communications from the voice processing unit 193 are transmitted to the base station 200 as RF signals by the RF signal processing unit 194.

The operation in reverse will now be described. The RF signals received from the base station 200 include internet information and voice communications and are demodulated by the data signal processing unit 192. The internet information is sent to the information display unit 182 and the voice communications are sent to the voice processing unit 193. The voice processing unit 193 converts the voice communications into a digital format. The information processing unit 182 receives the internet information from the mobile transceiver unit 190, displays and stores the internet information, and converts the internet information into a voice signal by voice synthesis. The information display unit 182-2 displays the internet information in a display interface, such as a panel, window, or screen. The information storage unit 182-4 stores the internet information in memory for later use.

While there have been illustrated and described what are considered to be preferred embodiments of the present invention, it will be understood by those skilled in the art that various changes and modifications may be made, and equivalents may be substituted for elements thereof, without departing from the true scope of the present invention. Accordingly, the invention is not be limited, except as by the following claims.

I claim:

1. An apparatus providing voice-interactive access to the internet via a wireless communication network, a gateway and a base station, comprising:
command control means for receiving voice commands from a subscriber and for converting the commands into a format compatible with the wireless communication network and the gateway;
data transceiver means for converting the voice commands from the command control means into a format for transmission to the base station as radio frequency (RF) signals;
information processing means for receiving information from the internet through the data transceiver means and for displaying and storing the received information; and
voice output means for outputting the received information in a voice format.

2. The apparatus of claim 1, wherein the command control means comprises:
voice interface means for converting voice communications and the voice commands into a digital format and for outputting the voice communications to the data transceiver means;
external command input means for entering commands through an external interface;
voice recognition means for converting the voice commands from the voice interface means into a text format using voice recognition;
command conversion means for converting the voice commands from the voice recognition means into commands compatible with the internet; and
protocol conversion means for converting the commands from the external command input means and the command conversion means into a format compatible with the protocol used between the wireless communication network and the gateway.

3. The apparatus of claim 2, wherein the data transceiver means comprises:
data signal processing means for converting the commands from the command control means into a frame format and for reconstructing information received from the internet;
voice processing means for converting the voice communications from the command control means into a frame format and converting voice communications received from the base station into a digital format; and
data processing means for transmitting the commands from the data signal processing means and the voice communications from the voice processing means as RF signals to the base station, and for demodulating RF signals received from the base station.

4. The apparatus of claim 3, wherein the information processing means comprises:
information processing control means for controlling the information processing means using the internet information received from the data signal processing means;
information display means for receiving the internet information from the data signal processing means and control messages from the information processing control means and displaying the internet information in a display interface;
information storage means for storing the internet information from the data signal processing means in memory for later use in accordance with control messages from the information processing control means; and
voice synthesis means for receiving internet information from the data signal processing means and control messages from the information processing control means and converting the internet information into a voice format by voice synthesis;
wherein the voice output means receives the voice communications from the voice processing means and the voice-synthesized information from the voice synthesis means and converts the voice communications and internet information into an analog signal and outputs the analog signal to an external voice interface.

5. A method providing voice-interactive access to the internet via a wireless communication network and a base station, comprising the steps of:
converting voice commands entered by a subscriber into a format compatible with the internet;
converting the voice commands into a format for transmission to the base station as radio frequency (RF) signals; and
processing information received from the internet for display and storage and outputting the internet information as a voice signal.

6. The method of claim 5, wherein the step of converting commands comprises the steps of:
converting voice communications and the voice commands entered by the subscriber into a digital format;
converting the digital voice commands into a text format using voice recognition; and
converting the commands in text format to commands that are compatible with the internet.

7. The method of claim 5, wherein the step of processing information comprises the steps of:
controlling the information processing using the internet information;
synthesizing a voice signal from the internet information using voice synthesis; and
storing the internet information in memory for later use.

8. An apparatus providing voice-interactive access to the internet via a wireless communications network, a gateway, and a base station using a hands-free kit, comprising:
hands-free kit means for receiving voice commands from a subscriber and for displaying and storing information received from the internet;
voice output means for outputting the internet information as a voice signal; and
mobile transceiver means for converting the commands received from the hands-free kit means to a format compatible with the wireless communication network and the gateway and for transmitting the commands to the base station as radio frequency (RF) signals.

9. The apparatus of claim 8, wherein the hands-free kit means comprises:
command control means for converting the commands received from the subscriber into a format compatible with the internet; and
information processing means for displaying the internet information in a text format.

10. The apparatus of claim 9, wherein the command control means comprises:
voice interface means for converting voice communications and the voice commands into a digital format;
voice recognition means for converting the voice commands from the voice interface means into a text format by voice recognition; and
command conversion means for converting the digital voice commands from the voice recognition means into commands compatible with the internet.

11. The apparatus of claim 9, wherein the information processing means comprises:
information processing control means for controlling the information processing means using the internet information from the mobile transceiver means;
information display means for receiving the internet information from the mobile transceiver means and control messages from the information processing control means and displaying the internet information in a display interface; and
information storage means for storing the internet information from the mobile transceiver means in memory for later use in accordance with control messages from the information processing control means.

12. The apparatus of claim 11, wherein the voice output means comprises:
voice synthesis means for receiving internet information from the mobile transceiver means and control messages from the information processing control means and for converting the internet information into a voice format using voice synthesis.

13. The apparatus of claim 10, wherein the mobile transceiver means comprises:
protocol conversion means for converting the commands into a format compatible with the protocol used between the wireless communication network and the gateway;
data signal processing means for converting the commands into a frame format and reconstructing internet information received from the base station;
voice processing means for converting the voice communications from the voice interface means into a frame format and converting voice communications received from the base station into a digital format; and
RF signal processing means for converting the commands from the data signal processing means and the voice communications from the voice processing means into RF signals and transmitting the RF signals to the base station, and for converting RF signals received from by the base station into a frame format.

14. A method providing voice-interactive access to the internet via a wireless communication network, a gateway, and a base station using a hands-free kit, comprising the steps of:
entering voice commands from a subscriber;
converting the commands into a format compatible with the wireless communication network and the gateway;
transmitting the commands to the base station as radio frequency (RF) signals;
processing information received from the internet for display and storage; and
outputting the internet information as a voice signal.

15. The method of claim 14, wherein the step of entering commands comprises the step of:
converting voice communications and the voice commands into a digital format;
converting the digital voice commands into a text format using voice recognition; and
converting the text commands into commands that are compatible with the internet.

16. The method of claim 14, wherein the step of processing internet information comprises the steps of:
controlling the information processing using the internet information; and
storing the internet information in memory for later use.
